(19) United States
(12) Patent Application Publication
(10) Pub. No.: US 2006/0261260 A1
(43) Pub. Date: Nov. 23, 2006

(54) Apparatus and method for measuring angular distribution of light

(76) Inventors: Zongkai Wang, Bronx, NY (US); Chunyu Wang, Bronx, NY (US)

Correspondence Address: ZONGKAI WANG, 953 Pierce Ave., Bronx, NY, 10462, US

(21) Appl. No.: 11/415,470

(22) Filed: May 2, 2006

Related U.S. Application Data
(60) Provisional application No. 60/683,443, filed on May 23, 2005.

(51) Int. Cl. G01D 5/34

(52) U.S. Cl. 250/231.1

(57) ABSTRACT

Apparatus and method for measuring angular distribution of light generated by visual displays or light emitting devices are provided. An optical probe can be rotated manually around test point; meanwhile the optical probe drives a goniometer. The goniometer provides angular location of the optical probe to a data acquiring circuit. The central axis of goniometer is separated from the central axis of the circular movement of optical probe. A Y shape cable transits light and angle information for data acquiring.

### TECHNICAL FIELD OF THE INVENTION

The present invention relates to test systems for measuring the light performance of visual displays and light emitting devices.

### BACKGROUND OF THE INVENTION

For measuring angular distribution of light generated by a visual display or a light emitting device, typically the object under test is rotated or the measuring apparatus is rotated around the test point. The test point is located on the axis of the rotation. In current measurement systems, either rotate an object under measurement or rotate the measurement apparatus, a mechanical member of the test system occupies the axis of the rotation partially. The mechanical member is a central shaft of a rotary stage or a system supporting part. Since the test point must be located on the rotational axis, the size of the object under measurement is limited. A typical prior art apparatus for measuring angular distribution of light by rotating display is disclosed in U.S. Pat. No. 6,177,955.

To accomplish above rotations, an active rotational device is required. The active rotational device may be a DC-motor or a step-motor. The active rotational device is heavy and needs mechanisms for installation, needs also a special power supply for driving. So the active rotational device makes the apparatus to be complex and large volume. Typical prior art apparatus are disclosed in U.S. Pat. No. 6,177,955, and MDS series products of autronic-MELCHERS GmbH, SS220 Display Test System of Microvision, Inc.

Mini potentiometer has features such as light, small volume, low power consumption, easy to use. Potentiometer can be a goniometer in the situation wherein the angular resolution and precision are not important, such as in a situation wherein the required precision is 5 degrees or larger. For display or light emitting device measurement, the expected angular resolution is one degree or less, therefore an independent potentiometer can not satisfy for the measurement because the linearity of the potentiometer is not good enough in a large angular range.

### SUMMARY OF THE INVENTION

It is therefore an object of the invention to provide a compact, potable and easy to use apparatus and a method for measuring angular distribution of light generated by visual displays and light emitting devices.

It is another object of the invention to provide an apparatus for measuring the angular distribution of light generated by visual displays without size limitation of the displays.

It is a further object of the invention to provide a method for measuring the angle by using a potentiometer under computer assistance.

This invention created said apparatus and said method to accomplish above objects.

An optical probe includes at least one lens and one optical fiber. The lens and optical fiber are fixed on the first mechanical member. The end of the optical fiber faces the lens and locates at focal point of the lens. The first mechanical member can move on second mechanical member circularly. The point under test is located on the central axis of said circular moving of the optical probe. The optical probe always points to the point under test and the lens focuses the light generated from said test point to said end of optical fiber.

A goniometer in the apparatus measures angular location of the optical probe. The rotational axis of said goniometer is separated from the axis of the circular movement of the optical probe. The rotational axis of the goniometer is parallel to the axis of the circular movement of the optical probe.

A third mechanical member connects the goniometer to the optical probe, so that the optical probe and the goniometer can rotate simultaneously. Since the optical probe is not concentric with the goniometer, the third mechanical member is fixed on rotational shaft of the goniometer and flexibly connected to optical probe.

The maximum rotational degrees for measuring angular distribution of light is 360°. Usually 180° is enough for measuring display or light emitting device. Therefore it is not necessary to rotate the optical probe by an active rotational device for only half circle. In this invention, the optical probe is moved manually, meanwhile the optical probe drives the goniometer, because the optical probe and the goniometer are connected by the third mechanical member.

The goniometer in this invention may be a potentiometer. For improving angular precision of the potentiometer, also for obtaining the actual angular location of the optical probe, the potentiometer is calibrated and it works under a computer assistance.

It is still for improving angular precision, a resistor is connected to the potentiometer. One of the terminals of said resistor is connected to midpoint detent of said potentiometer. This connection method can enlarge dynamic range of the potentiometer.

An electrical field is applied to the potentiometer. The voltage of the potentiometer related to rotational angle is obtained from midpoint detent of the potentiometer. And then this voltage is transited to actual angle of the optical probe by computer program.

A Y shape cable connects the optical probe and potentiometer to light receiving element and data acquiring circuit separately. Y shape cable includes optical fiber and conducting wires of the potentiometer. Said optical fiber and conducting wires are packed in one hose as first branch of the Y shape cable and packed in separated hoses as the second and third branches of the said Y shape cable. The second branch includes optical fiber, it connects to a light receiving element; the third branch includes conducting wires of potentiometer and it connects to data acquiring circuit.

The operating procedures are: align the optical probe to point the intended test point; start test program; apply a electrical filed across the potentiometer; rotate the optical probe around the test point manually in an intended angle range; the movement of optical probe drives the potentiometer; the data acquiring is started upon the optical probe moving, to detect voltage vary of the potentiometer can identify whether or not the optical probe starts the moving; the data acquiring circuit acquires luminance from said light receiving element and angular location of the optical probe from said potentiometer alternatively upon the rotary started; the computer assigns the luminance to corresponding angles; finally the computer gives a chart of angular distribution of luminance.

### BRIEF DESCRIPTION OF THE DRAWINGS

FIG. 1 is a system configuration of the inventive apparatus according to preferred embodiment of the invention.

FIGS. 2A and 2B are the mechanisms of the inventive apparatus.

FIG. 3 is Y shape cable.

FIG. 4 is electronics and their connections.

FIG. 5 is mechanism for angular calibration. It is backside of FIG. 2A.

FIG. 6 is flow chart of software.

FIG. 7 is a chart of output of the potentiometer varies with angle before and after improvement. After the improvement by connecting a resistor, the dynamic range of the potentiometer is enlarged.

FIG. 8 is the connecting bar made of patterned PCB. Shadow area is conducting layer.

### DESCRIPTION OF THE PREFERRED EMBODIMENT

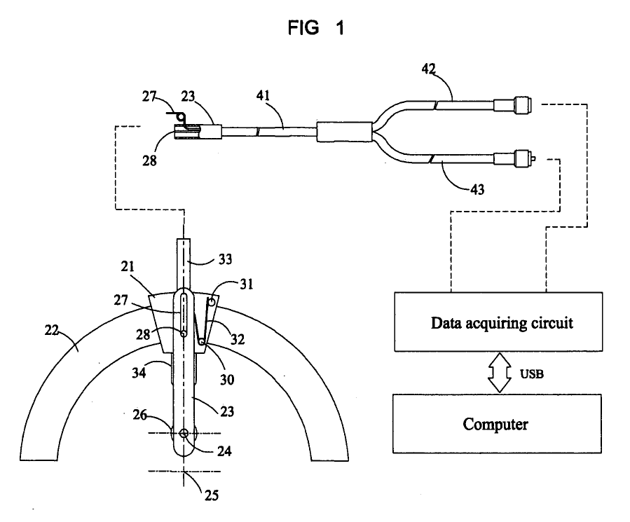

The system configuration of this embodiment is shown as FIG. 1.

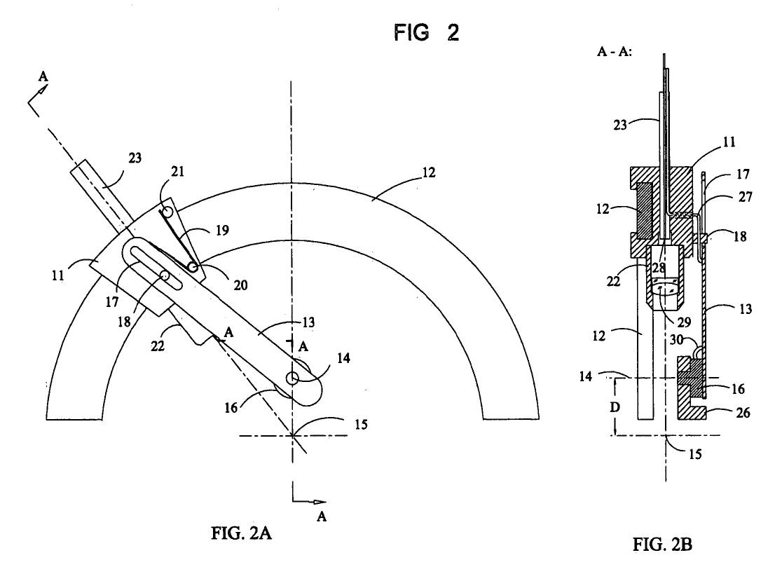

Referring to FIG. 2A and FIG. 2B, a slipping block 11 can move on a circular guide 12. There is a lens holder 22 with a lens 29 jointed on the slipping block. An optical fiber 28 is fixed in the slipping block. The lens, lens holder and the optical fiber consist of the optical probe.

The optical probe always points to test point 15. It collects the light from the test point 15 and then focuses the light on the end of the optical fiber 28.

A potentiometer (EVWAE, Panasonic) 16 is centered on axis 14. 26 is a support of the potentiometer. D is the distance between the axis of circular movement of the optical probe and the rotary axis of the potentiometer.

A connecting bar 13 is fixed on the rotary axis of the potentiometer. On the other side of the connecting bar, there is a slit-hole 17. A pin 18 is fixed on the slipping block. The pin can slip inside the slit-hole of the connecting bar, so that the pin 18 can drive the connecting bar moving around the axis 14 and therefore drive the potentiometer rotating upon the slipping block 11 moving.

A spring 19 presses the connecting bar 13 on the pin 18, so that there is no backlash between the connecting bar and the slipping block. The spring is held by screws 20 and 21.

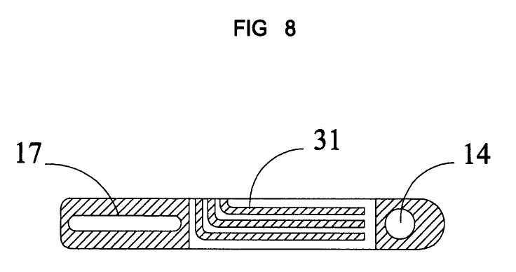

The connecting bar 13 is made of printed circuit board. The printed circuit board is patterned to extend the wires of the potentiometer 16. FIG. 8 is the connecting bar. 31 shows conducting lines for extending the wires of potentiometer.

A handle 23 for moving the optical probe is jointed with the slipping block. The center of the handle is empty, the optical fiber and the wires of potentiometer are put into the handle from one end of the handle and guided out from the other side of the handle.

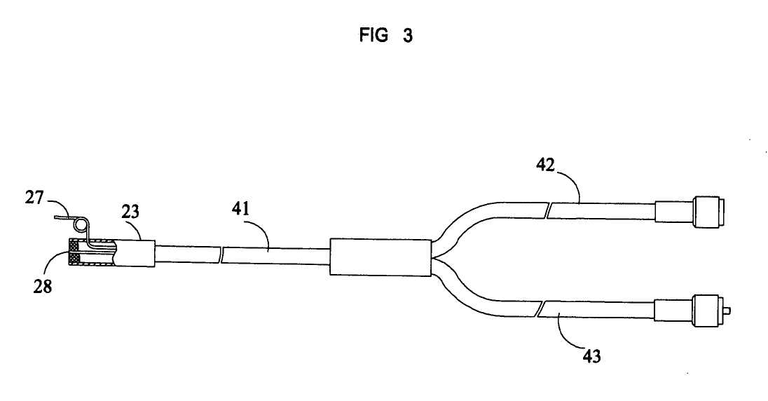

A Y shape cable FIG. 3 connects the optical fiber and wires of potentiometer 27 to light receiving element and data acquiring circuit separately. Said optical fiber and conducting wires are packed in one hose as first branch 41 of the Y shape cable and packed in separated hoses as the second branch 43 and third branch 42 of the said Y shape cable. The second branch includes optical fiber, and it connects to light receiving element; the third branch includes conducting wires, and it connects to data acquiring circuit.

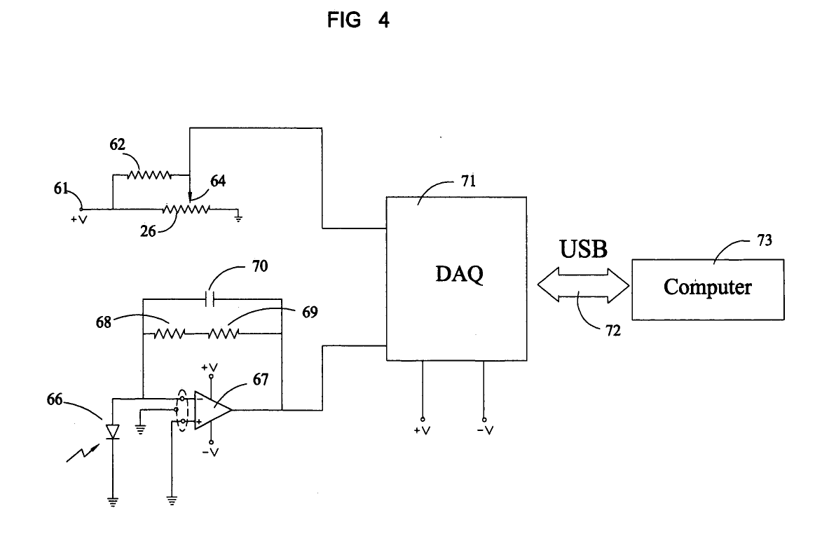

The light receiving element 66 in FIG. 4 is a photodiode (S7686, Hamamatsu). The signal generated by the photodiode is amplified by a pre-amplifier. The operational amplifier 67 is OPA124. Resistors 68 and 69 are 1M ohm, and the capacitor 70 is 100 pF.

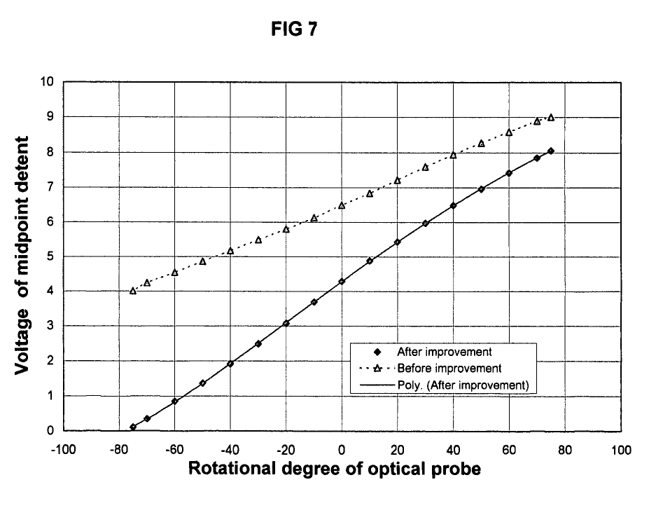

A resistor 62 is connected to potentiometer 26. One of the terminals of said resistor is connected to midpoint detent 64 of said potentiometer. This connection can enlarge dynamic range of the potentiometer. Potentiometer 26 is 10 kΩ. Resistor 62 is 100 kΩ. The dynamic ranges of the potentiometer are shown in FIG. 7 including the curves before improvement and after improvement by connecting the resistor. The dynamic range is the range of voltage varying vs. rotational angle of the potentiometer. In this embodiment, the dynamic range was 5 volts in 160 degrees before the improvement, and is 8 volts after the improvement.

Data acquiring circuit board 71 is UA307 (16 bit, 500 kHz, Youcai, Inc). One channel of the data acquiring circuit acquires data from pre-amplifier as light channel, and the other channel of the data acquiring circuit board acquires data from potentiometer as angle channel. This circuit board also provides power supply for pre-amplifier 67 and potentiometer 26. In this embodiment the data acquiring circuit provides ±15V to pre-amplifier and +15V crossing the potentiometer. A USB cable 72 is connected to a computer.

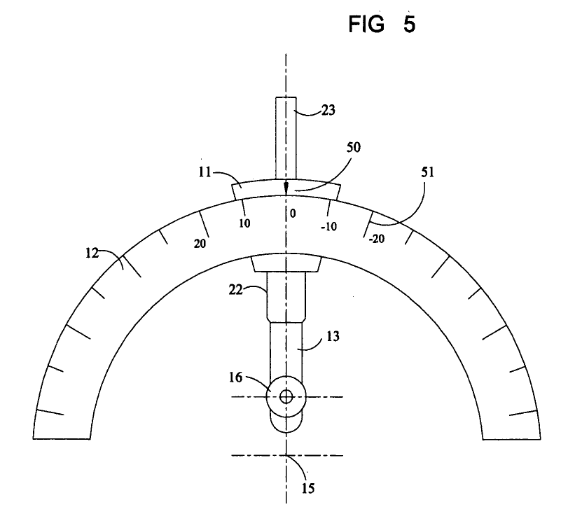

This inventive apparatus needs angular calibration at manufactory. There are angular scales 51 on the circular guide 12 (FIG. 5), and calibration line 50 on the slipping block 11. The angular location of the calibration line 51 is the angular location of the optical probe. The angular range in this embodiment is ±80°.

The procedures of the calibration are: apply a 15 volts electrical field at 61, move the optical probe from −80° to +80° in a step 5°; measure the voltages of midpoint detent 64 of potentiometer; get a chart of the angle varied with voltage; the potentiometer has good angle-voltage linearity in a range of 5°, so that the angular location of the optical probe can be identified by the voltage of the midpoint detent of the potentiometer in a resolution of one degree or less.

The system operation procedures are:

Align the apparatus described in this embodiment or the object under measurement to make the intended test point at the position 15;

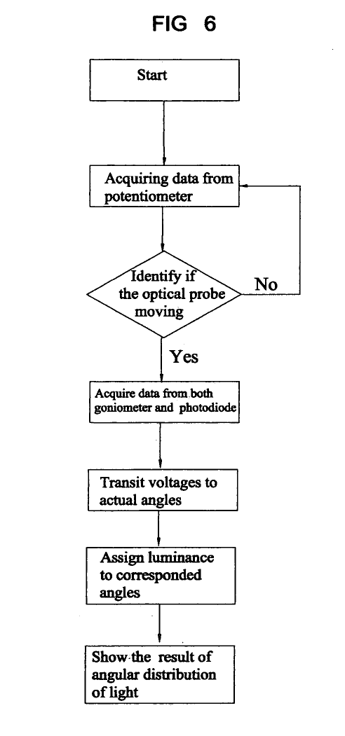

Start the computer program, the flow chart of the program is shown in FIG. 6.

Acquire voltage of potentiometer to check whether or not the optical probe is moving;

Move the optical probe manually in a range wherein the light parameters are wanted;

Upon the optical probe moving, the computer acquires data from both light channel and angle channel alternatively in an acquiring rate of 50 k Hz. The data acquiring is implemented for 5 seconds. Totally the computer obtains 250,000 data in this duration or obtains 125,000 data from each channel of light and angle. Averagely the computer obtains 780 data from each light channel and angle channel in a range of one degree;

The program assigns the luminance to corresponding angles;

Finally the computer gives a chart of the luminance varies with angle. This is the angular distribution of light.

### Embodiment 2

Replacing the photodiode with a spectrometer, the apparatus can measure both angle-distribution and wavelength-distribution of light.

1. Apparatus for measuring angular distribution of light generated by visual displays or light emitting devices comprising: an optical probe jointed on the first mechanical member, a second mechanical member on that the first mechanical member can move circularly, a goniometer for detecting the angular location of the optical probe, a third mechanical member for connecting optical probe and goniometer, a Y shape cable for both electrical and optical signals transiting.

2. The apparatus of claim 1 wherein the first mechanical member can move on the second mechanical member circularly in an angular range of 360 degrees or less.

3. The apparatus of claim 1 wherein the optical probe can move along with the first mechanical member and always points to the test point, the test point is located on the axis of the said circular moving.

4. The apparatus of claim 1 wherein the central axis of the circular moving of the optical probe is not occupied by any physical member of the said apparatus.

5. The apparatus of claim 1 wherein the optical probe includes at least one lens and one optic fiber or light receiving element.

6. The apparatus of claim 1 wherein the rotational axis of said goniometer is separated from the axis of said circular moving of optical probe; the rotational axis of the goniometer is parallel to the central axis of the circular moving of optical probe.

7. The apparatus of claim 1 wherein said optical probe and goniometer are connected by a third mechanical member; the third mechanical member is fixed on the rotational axis of said goniometer, and flexibly jointed to the first mechanical member.

8. The apparatus of claim 1 wherein said goniometer and optical probe can be rotated simultaneously.

9. The apparatus of claim 1 wherein said Y shape cable includes optical fiber and conducting wires of said goniometer.

10. The Y shape cable of claim 9 wherein said optical fiber and conducting wires are packed in one hose as one of the branches of the said Y shape cable and packed in separated hoses as the other two branches of the said Y shape cable.

11. A method for measuring angular distribution of light generated by a visual display or light emitting device comprising a step of rotating the optical probe around test point manually under a computer assistance.

12. The method of claim 11 wherein the rotating direction and speed may be changed randomly among the intended angular range in the duration of test.
